(19) United States
(12) Patent Application Publication
(10) Pub. No.: US 2024/0326633 A1
(43) Pub. Date: Oct. 3, 2024

(54) VEHICLE CHARGING SYSTEM

(71) Applicant: TOYOTA JIDOSHA KABUSHIKI KAISHA, Toyota-shi (JP)

(72) Inventors: Kensuke NAKANISHI, Toyota-shi (JP); Yoshihiro SAKAYANAGI, Toyota-shi (JP)

(73) Assignee: TOYOTA JIDOSHA KABUSHIKI KAISHA, Toyota-shi (JP)

(21) Appl. No.: 18/618,362

(22) Filed: Mar. 27, 2024

(30) Foreign Application Priority Data
Mar. 28, 2023 (JP) 2023-052231

(51) Int. Cl. B60L 53/66; B60L 53/18; B60L 53/65; G06Q 20/40; H02J 7/00

(52) U.S. Cl. CPC B60L 53/665; B60L 53/18; B60L 53/65; G06Q 20/401; H02J 7/0042

(57) ABSTRACT

A vehicle charging system of the present disclosure includes a charging device that externally charges a battery of an electric vehicle, an imaging device, and a management device. The management device is configured to acquire either vehicle identification information of the electric vehicle connected to the charging device or user identification information of a user of the electric vehicle from image data captured by the imaging device. Further, the management device is configured to link outstanding payment information indicating that a charging fee is not paid in response to completion of a charging of the battery to either the acquired vehicle identification information or the acquired user identification information so as to store the information in a memory device. As a result, the charging of the vehicle is allowed to a wide range of users and the outstanding payment information of the charging fee is properly managed.

### CROSS-REFERENCE TO RELATED APPLICATION

The present disclosure claims priority to Japanese Patent Application No. 2023-052231 filed on Mar. 28, 2023, which is incorporated herein by reference in its entirety including specification, drawings, and claims.

### TECHNICAL FIELD

The present disclosure relates to a vehicle charging system including a charging device that externally charges a battery of an electric vehicle.

### BACKGROUND

A conventionally known charging system includes a management server, a charging device, and a payment system (see, for example, Patent Document 1). The charging system extracts a unique MAC address of a vehicle connected to the charging device and uses the extracted MAC address and customer information provided at the time of membership subscription to perform membership subscription procedures, membership authentication procedures, charging procedures, a convenient payment for members, and a credit card payment with a deferred payment. Further, the management server stores the MAC address of the vehicle and information on outstanding (unpaid) fee, and allows the charging system to check charging history of the vehicle based on the MAC address.

### CITATION LIST

### Patent Literature

[Patent Literature 1] Japanese Patent Application Laid Open No. 2022-151487

### SUMMARY

However, when the MAC address of the vehicle is not acquired, the above charging system does not maintain the charging history of the vehicle, thereby making it difficult to collect the outstanding fee. On the other hand, user convenience may be impaired when the charging in the charging system is prohibited because the MAC address of the vehicle is not acquired. Further, in the case of so-called visitor charging, authentication of a payment method is assumed prior to a start of the charging, and often not only the MAC address, but also the vehicle identification information is not obtained. Therefore, in the visitor charging, a procedure to start the charging is complicated, and the charging by the charging system may not be initiated.

A main object of the present disclosure is to provide a vehicle charging system that allows a wide range of users to charge their vehicles while appropriately managing outstanding payment information on a charging fee.

A vehicle charging system of the present disclosure includes a charging device that externally charges a battery of an electric vehicle, an imaging device, and a management device. The management device is configured to acquire either vehicle identification information of the electric vehicle connected to the charging device or user identification information of a user of the electric vehicle from image data captured by the imaging device. This enables either the vehicle identification information or user the identification information to be acquired regardless of a specification of the electric vehicle connected to the charging device, thereby allowing a wide range of users to charge their electric vehicles. Further, the management device is configured to link outstanding payment information indicating that the charging fee is not paid in response to completion of a charging of the battery to either the acquired vehicle identification information or the acquired user identification information so as to store the information in a memory device. As a result, the charging of the vehicle is allowed to the wide range of users and the outstanding payment information of the charging fee is properly managed.

### BRIEF DESCRIPTION OF DRAWINGS

FIG. 1 is a schematic configuration diagram illustrating the vehicle charging system of the present disclosure;

FIG. 2 is a flowchart exemplifying a routine executed by the management device of the vehicle charging system of the present disclosure;

FIG. 3 is a flowchart exemplifying the routine executed by the management device of the vehicle charging system of the present disclosure; and

FIG. 4 is a flowchart exemplifying the routine executed by the management device of the vehicle charging system of the present disclosure.

### DESCRIPTION OF EMBODIMENTS

The following describes some aspects of the present disclosure with reference to drawings.

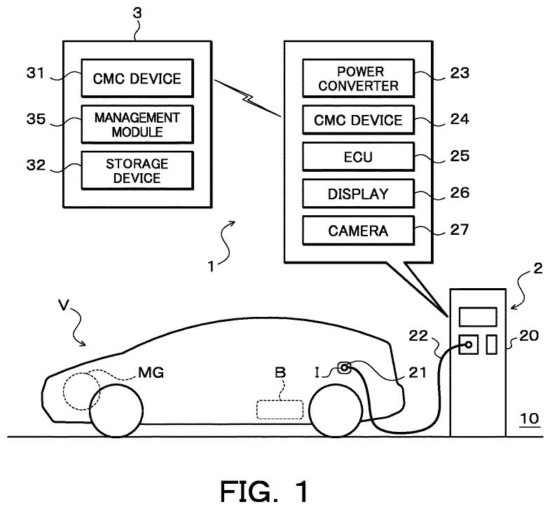

FIG. 1 is a schematic diagram illustrating a vehicle charging system 1 of the present disclosure. The vehicle charging system 1 shown in FIG. 1 includes a charging device 2 capable of externally charging a battery (high-voltage battery) B of an electric vehicle V, and a management server 3. The electric vehicle V is either a battery electric vehicle (BEV) or a plug-in hybrid electric vehicle (PHEV) that includes, in addition to the battery B, a motor generator MG that exchanges electric power with the battery B via a power control unit (PCU), which is not shown in the figure.

The charging device 2 of the vehicle charging system 1 is installed at a so-called quick charging station 10. As shown in FIG. 1, the charging device 2 includes a housing 20, a charging cable 22 including a charging connector 21, an electric power converter (“electric power equipment”) 23, a communication device 24, and an electronic control unit (hereinafter referred to as “ECU”) 25 as a charging controller. The charging cable 22 includes a positive pole side power supply line connected to the positive pole terminal of the charging connector 21, a negative pole side power supply line connected to a negative pole terminal of the charging connector 21, and communication lines connected to signal terminals of the charging connector 21. Further, the charging cable 22 is connected to the electric power converter 23.

The electric power converter 23, the communication device 24, and the ECU 25 are disposed in the housing 20 in this embodiment. The electric power converter 23 includes a rectifier circuit, a transformer, a switching circuit and the like, and converts AC power supplied from an AC power source such as a commercial power source into DC power. When the charging connector 21 is plugged into a charging inlet I of the electric vehicle V, the electric power converter 23 is electrically connected to the charging inlet I via the charging cable 22 and the charging connector 21. The communication device 24 exchanges various information with the management server 3 shown in FIG. 1 and the like through high-speed data communication (packet communication) by wireless or wired.

The ECU 25 of the charging device 2 includes a computer (not shown) with CPU, ROM, RAM, and the like. When the charging connector 21 is plugged into the charging inlet I of the electric vehicle V and relays of the electric vehicle V are closed, the ECU 25 controls the electric power converter 23 based on detected values of current sensors, voltage sensors, and the like (not shown). As a result, the battery B of the electric vehicle V is charged with electric power (DC power) from the charging device 2, that is, the electric power converter 23. Further, the ECU 25 exchanges information with an electronic control unit (ECU) of the electric vehicle V via the communication lines of the charging cable 22 when the charging connector 21 is plugged into the charging inlet I of the electric vehicle V.

The charging device 2 further includes a display device 26, such as a liquid crystal display, and a camera 27 as an imaging device. The display device 26 is mounted on the housing 20 and is controlled by the ECU 25. The ECU 25 displays information on the display device 26 to a user of the electric vehicle V parked in a parking space of the quick charging station 10. The information displayed on the display device 26 includes information on use of the charging device 2 and information on payment of a charging fee by a charging authentication card or cashless payment. The camera 27 is installed in the housing 20 or in the vicinity of the housing 20 and is capable of capturing images of at least a license plate of the electric vehicle V parked in the parking space. The camera 27 sends the captured image data to the ECU 25.

The management server 3 is established and managed by, for example, a company operating the quick charging stations 10, and functions as a management device that manages usage status of a large number of the charging devices 2, payment status of the charging fee, and the like in cooperation with the ECU 25 of the charging device 2. Further, the management server 3 cooperates with the ECU 25 of the charging device 2 to authenticate payment with the charging authentication card. The management server 3 includes a computer (not shown) with CPU, ROM, RAM, an I/O device and the like, a communication device 31, and a storage device 32. As shown in FIG. 1, the management module 35 is constructed in the management server 3 by cooperation of hardware such as CPU, ROM, and RAM, and programs installed in advance.

The communication device 31 exchanges various information with the communication device 24 of the charging device 2, authentication server for cashless payment (not shown) and the like through wireless or wired high-speed data communication (packet communication). The storage device 32 stores a database that links the usage status (usage history) and the payment status of the charging fee of the charging device 2 to vehicle identification information of a number of vehicles including the electric vehicle V and/or user identification information of the user of the electric vehicle V and the like. The vehicle identification information includes a vehicle identification number (VIN), a vehicle number and the like of the electric vehicle V. The user identification information includes the driver's license number of the user of the electric vehicle V, contact information such as a cell phone number, and a user ID assigned to the user (owner) of the electric vehicle V by a manufacturer of the vehicle and the like. The management module 35 executes processes for creating and updating the above database, extracting information from the database, and the like.

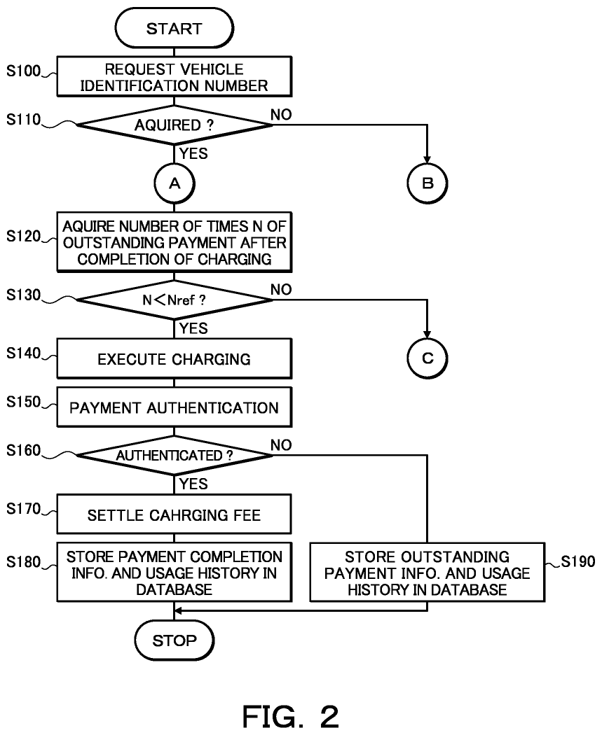

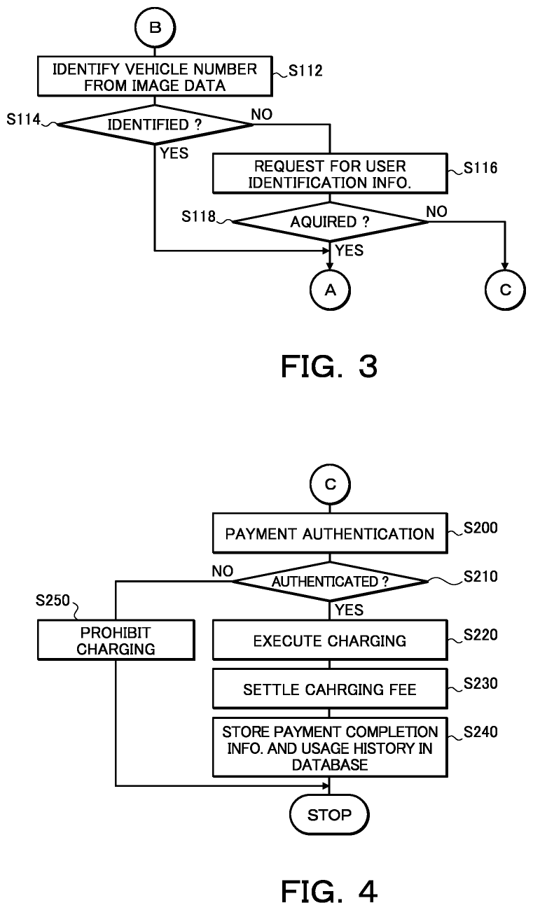

FIG. 2, FIG. 3 and FIG. 4 are flowcharts illustrating a routine executed by the management module 35 of the management server 3 in cooperation with the ECU 25 of the charging device 2.

When the electric vehicle V is parked in the parking space of the quick charging station 10 for charging the battery B, the camera 27 of the charging device 2 captures at least the license plate of the electric vehicle V. After parking the electric vehicle V in the parking space, the user of the electric vehicle V plugs the charging connector 21 into the charging inlet I in accordance with the guidance displayed on the display device 26. When the charging connector 21 is plugged into the charging inlet I, the management module 35 of the management server 3 is notified that the electric vehicle V is connected to the charging device 2. In response to a notification from the charging device 2, the management module 35 requests the ECU 25 to acquire the vehicle identification number (VIN code) of the electric vehicle V (step S100). The ECU 25 requests an ECU of the electric vehicle V to send the vehicle identification number via the communication line of the charging cable 22 and sends the acquired vehicle identification number of the electric vehicle V to the management server 3 (step S100).

The management module 35 of the management server 3 determines whether the vehicle identification number of the electric vehicle V is acquired from the ECU 25 (step S110). When the vehicle identification number is not acquired from the ECU 25 (step S110: NO), the management module 35 requests the ECU 25 to send the image data captured by the camera 27, as shown in FIG. 3. Further, the management module 35 identifies the vehicle number of the electric vehicle V connected to the charging device 2 based on the image data from the ECU 25 (step S112). The management module 35 also determines whether the vehicle number of the electric vehicle V is identified (step S114). When the vehicle number of the electric vehicle V is not identified (step S114: NO), the management module 35 requests the ECU 25 to acquire user identification information (personal information) of the user of the electric vehicle V. The ECU 25 requests the user of the electric vehicle V connected to the charging device 2 to provide user identification information (personal information) via the display device 26 (step S116).

In step S116, the ECU 25 requests the ECU of the electric vehicle V to send, via the communication lines of the charging cable 22, a user ID capable of identifying an individual issued by the manufacturer of the electric vehicle V, and sends the acquired user ID to the management server 3. When the user ID is not acquired from the electric vehicle V, the ECU 25 requests the user to take a picture of a card or the like with the user identification information by the camera 27 or another camera via the display device 26. The card with the user identification information is, for example, an identification card (identification document) such as a driver's license or the like. When the user accepts the taking of a driver's license or the like, the ECU 25 sends the image data captured by camera 27 or the like to the management server 3. The management module 35 acquires the user identification information (for example, driver's license number, or the like) of the user of the electric vehicle V based on the image data from the ECU 25. When the user does not accept the taking of the card or the like with the user identification information by the camera 27 or the like, the ECU 25 requests registration of personal information (for example, a cell phone number) to a website indicated by a two-dimensional code (matrix type two-dimensional code) displayed on the display device 26. In this case, identification is executed by SMS authentication using the cell phone number, and user identification information is notified to the management server 3 after the identification is completed. After the process of step S116, the management server 3 determines whether or not the user identification information is acquired from the user of the electric vehicle V (step S118).

When the vehicle identification number is acquired from the electric vehicle V (step S110: YES), when the vehicle number is acquired from the electric vehicle V (step S114: YES), or when the user identification information is acquired from the user of the electric vehicle V (step S118: YES), the management module 35 acquires (extracts) outstanding payment information corresponding to the acquired vehicle identification number, the acquired vehicle number or the acquired user identification information from the database in the storage device 32 (step S120). In this embodiment, the outstanding payment information acquired in step S120 indicates number of times N of outstanding payment of the charging fee that is to be paid in response to completion of a charging of the battery B by the charging device 2, regardless of whether the charge fee is paid afterwards or not. When there is no number of times N of outstanding payment corresponding to the vehicle identification number, the vehicle number or the user identification information, the management module 35 links the vehicle identification number or the like to the number of times N=0 and stores it them the database of the storage device 32.

After the process of step S120, the management module 35 determines whether the acquired number of times N of outstanding payment is less than a predetermined threshold value Nref (for example, 2-5 times) (step S130). When the number of times N of outstanding payment is less than the threshold value Nref (step S130: YES), the management module 35 sends a command signal to the ECU 25 to instruct the ECU 25 to execute the charging of the battery B of the electric vehicle V (step S140). In response to the command signal from the management server 3, the ECU 25 promptly starts the charging of the battery B of the electric vehicle V with electric power from the electric power converter 23 and stops the charging of the battery B when SOC of the battery B reaches a predetermined target value (step S140).

After the charging of battery B is completed, the management module 35 authenticates a payment method of the charging fee by the user (step S150). In step S150, when the payment method of the charging fee is linked to the vehicle identification number, the vehicle number or the user identification information, the management module 35 completes the authentication of the payment method. When no payment method for the charging fee is linked to the vehicle identification number or the like, the management module 35 sends a command signal to the ECU 25 to instruct the user to confirm the payment method of the charging fee. The ECU 25 requests the user to select, via display device 26, one of following payment options: payment by the charge authentication card, payment by cashless payment (credit card, debit card, electronic money, code payment, or the like), or a deferred payment through a dedicated website or the like. When the user selects the payment by the charge authentication card or the cashless payment, the ECU 25 sends card information read by a card reader (not shown) of the housing 20 to the management server 3. The management module 35 of the management server 3 executes the authentication of the payment method based on the card information from the ECU 25.

When the authentication of the payment method of the charging fee is completed (step S160: YES), the management module 35 acquires an amount of electric power spent on the charging of the battery B from the ECU 25 and settles the charging fee in accordance with the amount of electric power (step S170). Further, the management module 35 links payment completion information of the charging fee and the usage history of the charging device 2, such as location, date and time of use, and charging fee (amount charged), to the vehicle identification number, the vehicle number, or the user identification information, and stores them in the database of the storage device 32 (step S180), and then terminates the routine.

When the payment method of the charging fee is not authenticated by the management server 3 or the like due to an expiration date of the card or insufficient balance of the electronic money, or when the authentication is not completed due to the user selecting the deferred payment (step S160: NO), the management module 35 links the usage history to the vehicle identification number, the vehicle number or the user identification information so as to store them in the database in the storage device 32 (step S190). Further, in step S190, the management module 35 updates the database by incrementing the number of times N of outstanding payment as the outstanding payment information and terminates the routine. The charging fee may be paid later, for example, by the cashless payment through a dedicated website provided by the management server 3. The charging fee may be paid later, for example, by the cashless payment through the dedicated website provided by the management server 3. When the deferred payment of the charging fee is completed, the management module 35 of the management server 3 resets the number of times N of outstanding payment linked to the corresponding vehicle identification information or the corresponding user identification information, and also updates the database in the storage device 32 by incrementing number of times of deferred payment linked to the vehicle identification information or the like.

On the other hand, when the vehicle identification information of the electric vehicle V is not acquired and the user identification information is not acquired from the user (step S118: NO), the management module 35 authenticates the payment method of the current charging fee by the user (step S200), as shown in FIG. 4. Further, when the number of times N of outstanding payment is equal to or more than the threshold value Nref (step S130: NO), the management module 35 authenticates the payment method of the current charging fee by the user (step S200). In step S200, the management module 35 sends the command signal to the ECU 25 to instruct the user to confirm the payment method of the charging fee. The ECU 25 requests the user to select, via the display device 26, either the payment by the charging authentication card or the payment by the cashless payment. That is, in the vehicle charging system 1, when the vehicle identification information of the electric vehicle V and the user identification information of the user are not acquired and when the number of times N of outstanding payment of the charging fee by the user is equal to or more than the threshold value Nref, the deferred payment of the current charging fee is disabled. When the user selects the payment by the charging authentication card or the cashless payment, the ECU 25 sends the card information read by the card reader to the management server 3. The management module 35 of the management server 3 authenticates the payment method based on the card information from the ECU 25.

When the authentication of the payment method of the charging fee is completed (step S210: YES), the management module 35 sends a command signal to the ECU 25 to instruct the ECU 25 to execute the charging of the battery B of the electric vehicle V (step S220). In response to the command signal from the management server 3, the ECU 25 starts the charging of the battery B of the electric vehicle V with the electric power from the electric power converter 23 and stops the charging of the battery B when the SOC of the battery B reaches the predetermined target value (step S220). After the charging of battery B is completed, the management module 35 settles the charging fee based on the amount of electric power spent on the charging of the battery B (step S230).

Further, the management module 35 stores the payment completion information of the charging fee and the usage history of the charging device 2 in the database of the storage device 32 (step S240), and then terminates the routine. When the vehicle identification number or the like is acquired, the management module 35 links the payment completion information and the usage history to the vehicle identification number or the like and stores them in the database of the storage device 32 in step S240. When the vehicle identification number or the like is not acquired, the management module 35 stores the payment completion information and the usage history in the database of the storage device 32 without linking them to the vehicle identification number or the like in step S240. In contrast, when the user does not select payment by the charge card or the cashless payment and the authentication authentication is not completed (step S220: NO), the management module 35 sends a command signal to the ECU 25 to prohibit the charging of the battery B of the electric vehicle V by the electric power from the electric power converter 23 (step S250) and terminates the routine. In response to the command signal from the management server 3, the ECU 25 displays on the display device 26 that the charging is disabled.

As described above, when the electric vehicle V is connected to the charging device 2, the management module 35 of the management server 3 of the vehicle charging system 1 acquires the vehicle identification number of the electric vehicle V as vehicle identification information via the charging cable 22 (steps S100, S110: YES) in cooperation with the ECU 25 of the charging device 2. When the vehicle identification number is not acquired from the electric vehicle V (step S110: NO), the management module 35 acquires the vehicle number of the electric vehicle V from the image data captured by the camera 27 as vehicle identification information (steps S112, S114: YES). Further, when both the vehicle identification number and the vehicle number of the electric vehicle V (vehicle identification information) are not acquired (step S114: NO), the management module 35 requests the user to provide the user identification information by image data (step S116) in cooperation with the ECU 25 of the charging device 2.

That is, the management module 35 of the management server 3 is capable of acquiring the vehicle number (vehicle identification information) of the electric vehicle V connected to the charging device 2 or the user identification information of the user of the electric vehicle V from the image data captured by the camera 27 or the like. This enables the vehicle identification information or the user identification information to be acquired regardless of the specification of the electric vehicle V connected to the charging device 2, thereby allowing a wide range of users to charge the electric vehicle V. Further, the management module 35 links the number of times N of outstanding payment as the outstanding payment information indicating that the charging fee is not paid in response to the completion of the charging of the battery B to the acquired vehicle identification information or the acquired user identification information and stores the information in the storage device 32 (step S190). As a result, in the vehicle charging system 1, the charging of the electric vehicle V is allowed to the wide range of users and the outstanding payment information of the charging fee is properly managed.

In the vehicle charging system 1, the management module 35 of the management server 3 links the number of times N of outstanding payment of the charging fee that is to be paid in response to the completion of the charging of the battery B to the vehicle identification information or the user identification information and stores them in the storage device 32. This enables to determine whether or not to allow the deferred payment of the charging fee by comparing the number of times N of outstanding payment with the threshold value Nref.

In the vehicle charging system 1, when the number of times N of outstanding payment is less than the threshold value Nref, the management module 35 of the management server 3 starts the charging of the battery B by the charging device 2 before authenticating the payment method of the charging fee by the user (step S130: YES, S140-S150). This improves convenience for users with a small number of times of outstanding payment of the charging fee. On the other hand, when the number of times N of outstanding payment is equal to or more than the threshold value Nref (step S130: NO), the management module 35 starts the charging of the battery B by the charging device 2 (step S220) on condition that the authentication of the current payment method is completed (steps S200 and S210: YES). This prevents the outstanding charging fee from being uncollectible by setting a certain limit on the number of times N of outstanding payment.

In the vehicle charging system 1, when the vehicle identification information (vehicle identification number and vehicle number) of the electric vehicle V is not acquired and the user identification information is not provided by the user of the electric vehicle V (step S118: NO), on condition that the authentication of the payment method of the current charging fee by the user is completed (steps S200, S210: YES), the management module 35 of the management server 3 starts the charging of the battery B by the charging device 2 (Step S220). This prevents the charging fee from being uncollectible when both the electric vehicle V and the user are not identified.

In the vehicle charging system 1, the number of times N of outstanding payment as the outstanding payment information is reset in accordance with the deferred payment of the charging fee. This prevents the deferred payment of the charging fee from being disabled due to an increase in the number of times N of outstanding payment. The management server 3 may identify users who frequently use the deferred payment of the charging fee and pay the charging fee without delay based on the above number of times of deferred payment, and change (increase) the threshold value Nref for the identified users in accordance with frequency of deferred payment. This further improves the convenience of users who frequently use the deferred payment of the charging fee. The number of times of deferred payment may be reset upon satisfaction of any reset condition, and may be reset every certain period of time (for example, every 1-3 months or so).

In step S100 of FIG. 2, the management module 35 of the management server 3 or the ECU 25 may obtain the vehicle identification number or the user ID issued by the manufacturer of the electric vehicle V from the in-vehicle communication device (not shown) of the electric vehicle V. The image data captured by camera 27 and the like may be sent directly from the camera 27 and the like to the management server 3. Further, regardless of whether the vehicle identification number is acquired or not, the vehicle number of the electric vehicle V may be acquired from the image data captured by the camera 27, and the user identification information may be acquired from the user of the electric vehicle V when the electric vehicle V is determined to be a rental car from the acquired vehicle number. This prevents the charging fee from being uncollectible from the user of the rental car by allowing the deferred payment of the charging fee to the user of the rental car on condition that the user identification information is acquired.

In step S120 of FIG. 2, The management module 35 of the management server 3 may acquire (extract) from the database stored in the storage device 32 total amount of the charging fee (outstanding fee) which is not paid upon the completion of the charging of the battery B. This enables to determine whether or not to allow the deferred payment of the charging fee by comparing the total amount of outstanding charging fee with a predefined threshold (upper limit of the outstanding fee). Further, the management module 35 may start the charging of the battery B by the charging device 2 before authenticating the payment method of the charging fee by the user when the total amount of outstanding charging fee is less than the threshold value. This improves convenience for users with a small number of times of outstanding payment of the charging fee. The management module 35 may also start the charging of the battery B by the charging device 2 on condition that the authentication of the payment method is completed when the total amount of outstanding charging fee is equal to or more than the threshold value. This prevents the outstanding charging fee from being uncollectible by setting a certain limit on the number of times N of outstanding payment.

In step S150 of FIG. 2 and step S200 of FIG. 4, the charging fee that is not paid so far may be charged together with the current charging fee. This allows the user to collectively pay the charging fees for multiple charges when charging the battery B of the electric vehicle V.

Some or all of the processing executed by the management module 35 of the management server 3 in the routine shown in FIGS. 2-4 may be executed by the ECU 25 of the charging device 2. Conversely, some or all of the processing performed by the ECU 25 of the charging device 2 in the routine shown in FIGS. 2-4 may be performed by the management module 35 of the management server 3.

In the vehicle charging system 1, the charging device 2 is not limited to those supplying DC power to the electric vehicle V (battery B). That is, the charging device 2 may supply AC power to the electric vehicle V that includes an AC/DC converter.

As has been described above, the vehicle charging system (1) of the present disclosure includes the charging device (2) that externally charges the battery (B) of the electric vehicle (V), the imaging device (27), and the management device (3, 35, 25). The management device (3, 35, 25) is configured to acquire either vehicle identification information of the electric vehicle (V) connected to the charging device (2) or user identification information of the user of the electric vehicle (V) from image data captured by the imaging device (27) (S100, S112, S116). Further, the management device (3, 35, 25) 5) is configured to link outstanding payment information indicating that the charging fee is not paid in response to completion of the charging of the battery (B) to either the acquired vehicle identification information or the acquired user identification information so as to store the information in the memory device (32).

The management device of the vehicle charging system of the present disclosure acquires either the vehicle identification information of the electric vehicle connected to the charging device or the user identification information of the user of the electric vehicle from image data captured by the imaging device. This enables either the vehicle identification 4 user identification information to be acquired regardless of the specification of the electric vehicle connected to the charging device, thereby allowing the wide range of users to charge their electric vehicles. Further, the management device links the outstanding payment information indicating that the charging fee is not paid in response to completion of the charging of the battery to either the acquired vehicle identification information or the acquired user identification information so as to store the information in the memory device. As a result, the charging of the electric vehicle is allowed to the wide range of users and the outstanding payment information of the charging fee is properly managed.

The management device (3, 35, 25) may be configured to acquire the vehicle identification number of the electric vehicle (V) as the vehicle identification information via the cable (22) that connects the charging device (2) to the battery (B) (S100). The management device (3, 35, 25) may be configured to acquire the vehicle number of the electric vehicle (V) from the image data captured by the imaging device (27) as the vehicle identification information (S112) when the vehicle identification number is not acquired (S110: NO).

This allows the vehicle identification information to be acquired regardless of the specification of the electric vehicle connected to the charging device.

The management device (3, 35, 25) may be configured to request the user to provide the user identification information (S116) when vehicle identification information of the electric vehicle (V) is not acquired (S114: NO). The management device (3, 35, 25) may be configured to start the charging of the battery (B) by the charging device (2, 23) (S220) on condition that authentication of the payment method of the charging fee by the user is completed (S200, S210: YES) when the user identification information is not provided from the user (S118: NO).

This prevents the charging fee from being uncollectible when both the electric vehicle and the user are not identified.

The management device (3, 35, 25) may be configured to link either the vehicle identification information or the user identification information to either the number of times (N) of outstanding payment of the charging fee that is to be paid in response to the completion of the charging of the battery (B) or the total amount of the charging fee that is not paid in response to the completion of the charging of the battery (B) so as to store them in the memory device (32) (S190).

This enables to determine whether or not to allow a deferred payment of the charging fee based on the number of times of outstanding payment or the total amount of the charging fee that has not been paid.

The management device (3, 35, 25) may be configured to start the charging of the battery (B) by the charging device (2, 23) before authenticating the payment method of the charging fee by the user (S140-S160) when the number of times (N) of outstanding payment or the total amount of the outstanding charging fee is less than the threshold value (Nref) (S130: YES). The management device (3, 35, 25) may be configured to start the charging of the battery (B) by the charging device (2, 23) on condition that authentication of the payment method is completed (S200, S210: YES, S220) when the number of times (N) of outstanding payment or the total amount of the outstanding charging fee is equal to or more than the threshold value (Nref) (S130: NO).

This improves convenience for users with a small number of times of outstanding payment of the charging fee, and also prevents the outstanding charging fee from being uncollectible by setting a certain limit on the number of times of outstanding payment.

The disclosure is not limited to the above embodiments in any sense but may be changed, altered, or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The technique of the present disclosure is applicable to, for example, the electric vehicle manufacturing industry and the like.

1. A vehicle charging system including a charging device that externally charges a battery of an electric vehicle, and an imaging device, the system comprising:
a management device configured to
acquire either vehicle identification information of the electric vehicle connected to the charging device or user identification information of a user of the electric vehicle from image data captured by the imaging device, and
link outstanding payment information indicating that a charging fee is not paid in response to completion of a charging of the battery to either the acquired vehicle identification information or the acquired user identification information so as to store the information in a memory device.

2. The vehicle charging system according to claim 1,
wherein the management device is configured to acquire a vehicle identification number of the electric vehicle as the vehicle identification information via a cable that connects the charging device to the battery, and
wherein the management device is configured to acquire a vehicle number of the electric vehicle from the image data captured by the imaging device as the vehicle identification information when the vehicle identification number is not acquired.

3. The vehicle charging system according to claim 2,
wherein the management device is configured to request the user to provide the user identification information when the vehicle identification information of the electric vehicle is not acquired, and
wherein the management device is configured to start the charging of the battery by the charging device on condition that authentication of a payment method of the charging fee by the user is completed when the user identification information is not provided from the user.

4. The vehicle charging system according to claim 1,
wherein the management device is configured to link either the vehicle identification information or the user identification information to either a number of times of outstanding payment of the charging fee that is to be paid in response to the completion of the charging of the battery or a total amount of the charging fee that is not paid in response to the completion of the charging of the battery so as to store them in the memory device.

5. The vehicle charging system according to claim 4,
wherein the management device is configured to start the charging of the battery by the charging device before authenticating the payment method of the charging fee by the user when the number of times of outstanding payment or the total amount of the outstanding charging fee is less than a threshold value, and
wherein the management device is configured to start the charging of the battery by the charging device on condition that authentication of the payment method is completed when the number of times of outstanding payment or the total amount of the outstanding charging fee is equal to or more than the threshold value.
